(19) United States
(12) Patent Application Publication
(10) Pub. No.: US 2005/0245354 A1
(43) Pub. Date: Nov. 3, 2005

(54) Inflatable slide with wind passage

(75) Inventor: Eduard Shaljyan, Valley Village, CA (US)

Correspondence Address: ROBERT D. FISH;RUTAN & TUCKER LLP, 611 ANTON BLVD 14TH FLOOR, COSTA MESA, CA, 92626-1931, US

(73) Assignee: Prosage Holdings Corp.

(21) Appl. No.: 10/799,520

(22) Filed: Mar. 12, 2004

(51) Int. Cl. A63B 17/00; B64B 1/02; A63B 9/00

(52) U.S. Cl. 482/35

(57) ABSTRACT

An inflatable play structure has a wind passage that helps stabilize the structure in high winds. The wind passage can be any suitable size or shape, but preferably has a vertical cross-section area of at least 0.5 m², and at least 1 m² for each m of structure height. The wind passage is especially useful for inflatable structures having slides.

### FIELD OF THE INVENTION

The field of the invention is inflatable play structures having a slide.

### BACKGROUND OF THE INVENTION

An inflatable play structure is made at least partially from deformable members that can be filled with air. Such deformable members are generally soft and bouncy and therefore thought to provide a high degree of safety. On the other hand, the safety of such structures can be compromised by the bouncy nature of the structure. For example, a child can be bounced into the air only to fall on solid ground. U.S. Patent Application No. 2002/0055309 addresses that problem by providing an inflatable slide that is surrounded by an inflatable platform.

Another safety problem that can occur with inflatable play structures, particularly tall structures, is instability. Such instability is at least partly a result of the affect of wind on the inflatable structure. Even structures having stabilizing members, such as the structure taught in U.S. Pat. No. 6,648,767, can be substantially altered or even blown over by wind. While inflatable slides have varying degrees of resistance to wind, any play structure with a base presenting a high wind resistance will be substantially affected by wind.

Thus, there is a need for a relatively tall inflatable play structure that is safe from the instability caused by wind.

### SUMMARY OF THE INVENTION

The present invention provides a tall inflatable play structure having a slide and a wind passage configured to be large enough to sufficiently reduce the affect of wind on the stability of the play structure. It is envisaged that the wind passage has a vertical cross-section of at least 0.5 m² and the slide is at least 4.8 m in height.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a side view of an inflatable play structure having a slide and a wind passage.

FIG. 2 is a side view of an alternative inflatable play structure having a slide and a wind passage.

FIG. 3 is a side view of an alternative inflatable play structure having a slide, additional inflatable support members, and a wind passage.

FIG. 4 is a top view of yet another an inflatable play structure having a slide and a wind passage.

FIG. 5 is a perspective view of yet another an inflatable play structure having a slide and a wind passage.

FIG. 6 is a side view of the interior structure of yet another inflatable play structure having a slide and a wind passage.

### DETAILED DESCRIPTION

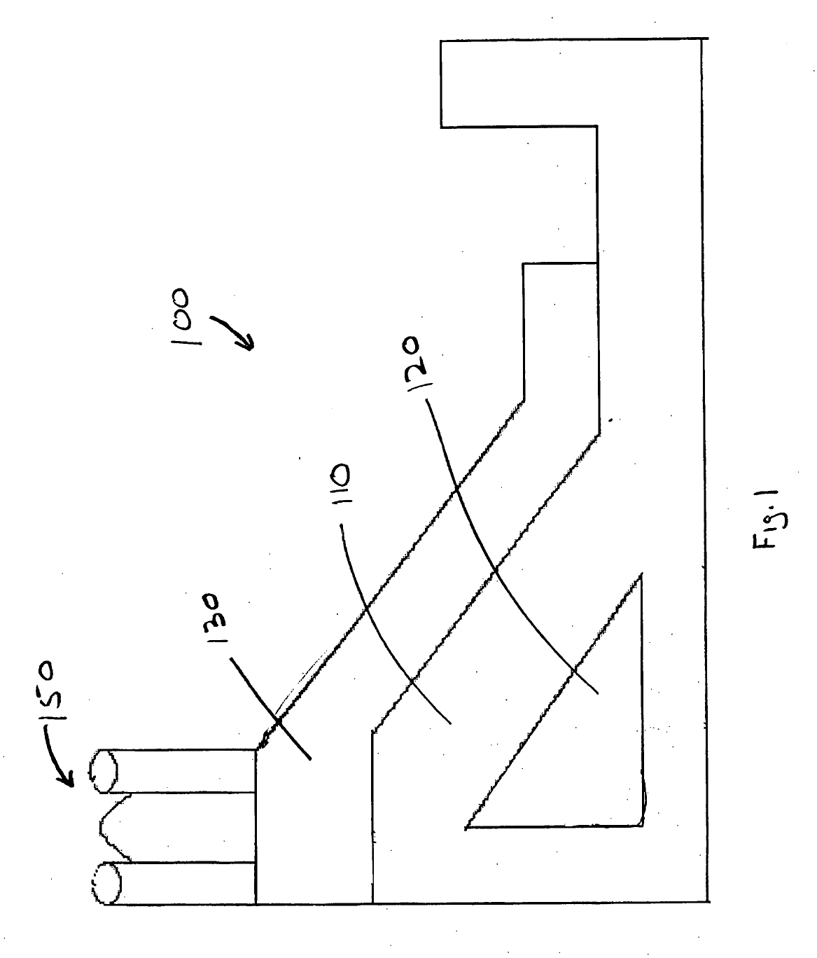

Referring first to FIG. 1, an inflatable slide 100 generally comprises an inflatable support base 110, a wind passage 120, and a side wall 130.

Inflatable slide 100 is made predominantly of a fiber reinforced fabric (e.g. 18.5 oz vinyl with fiber reinforcement. The fabric is formed into airtight compartments that can be filled with air to create the overall form of the play structure. Of course, other suitable materials can be substituted for the fiber reinforced fabric so long as the materials are capable of retaining air and being deformable. Preferable materials are resistant to tearing, puncturing, and the effects of extreme temperature. It is also advantageous to treat constituent materials with UV protection, water repellant, and fire retardant additives.

The inflatable slide 100 can be made from one or more airtight compartments. In a case where there is more than one separate compartment it is still desirable to couple the separate compartments together so that air being blown into the inflatable slide is able to come from only one intake valve. In addition, it is known in the art to decorate inflatable play structures with colors, figures, and characters. The structure in FIG. 1 has a canopy 150 that is not inflatable, but is decorative and provides a region of shade for children waiting to get on the slide.

Support base 110 is an inflatable compartment that receives pressure from the weight of children standing on it. Side wall 130 depends from the surface of the slide or climbing portion. The invention is especially applicable to slides having a height of at least 4.8 m (about 15 feet). Up to now, it has not been appreciated that at such a height, a significantly sized wind passage is desirable to reduce the affect of the horizontal force of wind on the stability of the structure. The invention being progressively more critical with larger slides, such as those at least 5.5 meters, 6, 7, 8, 9, or 10 meters tall.

It is known that wind speed and direction can be measured with an anemometer, and that strain gauges can be used to measure how the wind affects a structure. But up to now it has not been appreciated that taller slides should be constructed with a wind passage to reduce the affects of the wind on the stability of the structure. Indeed, taller slides should have larger wind passages. Wind passage 120 is a channel or opening that allows wind to “pass through” a portion of the support base 110 of the structure. In addition to the having a rather significant vertical cross-sectional area, preferred wind passages are relatively free from items that would inhibit the wind from flowing through the passage.

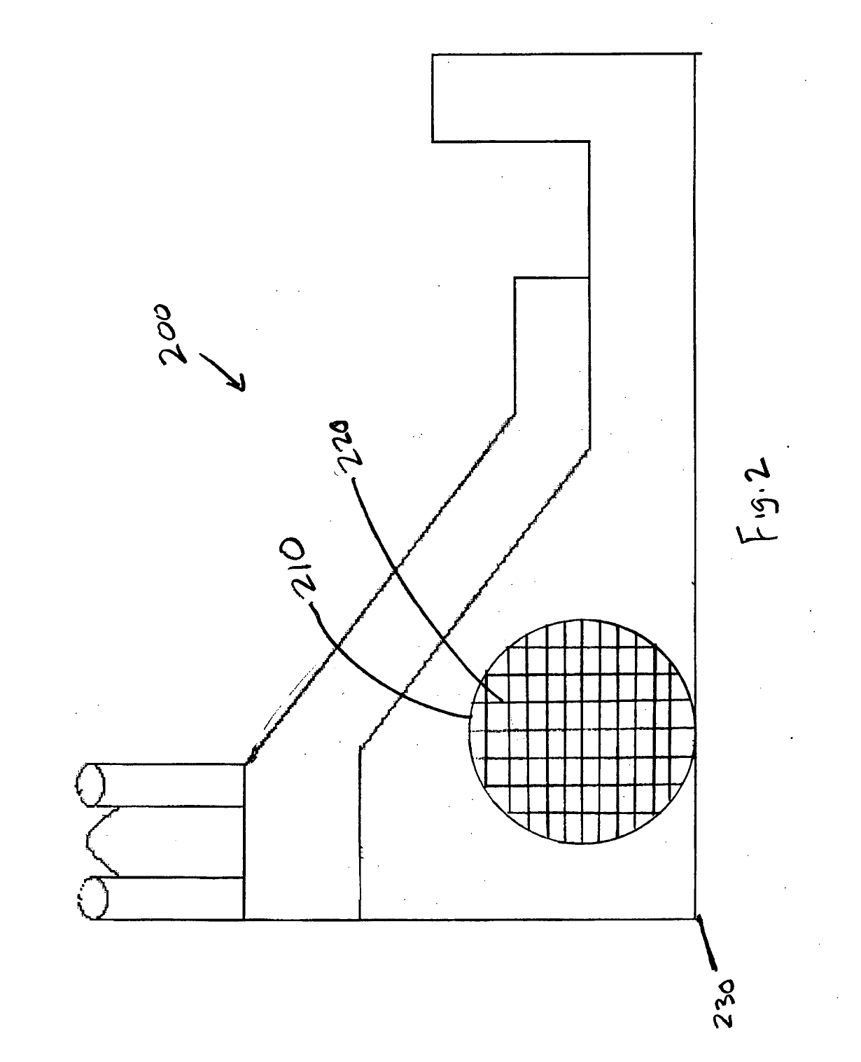

FIG. 2 depicts an inflatable structure 200 having a wind passage 210 with a circular vertical cross-section. It should be appreciated that almost any shape will suffice so long as the vertical cross-sectional area of the passage (i.e. the area “seen” by the wind) sufficient to provide adequate stabilization. Preferred structures have a vertical cross-section area of at least 0.1 m² for each m of structure height. Yet more preferred structures have a vertical cross section area of at least 0.2 m² for each m of structure height. Thus, a five meter slide should have a wind passage at least 0.5 m² in vertical cross-section, and a seven meter slide should have a wind passage at least 0.7 m² in vertical cross-section. The wind passage can even be split among multiple tunnels, where it is preferred that the sum of the vertical cross-sections of the multiple tunnels is at least 0.1 m² for each m of structure height.

Other preferred shapes for wind passages are oblong and triangular. In the case of triangular, hexagonal or other shapes having angles, it should be appreciated that the “angles” will likely be rounded.

As used herein, the term “vertical cross-section” of the wind passage refers to the smallest vertical cross-section “seen” by the wind traveling through the passage. This definition is adopted because it is the smallest cross-section that provides the limiting factor with respect to wind resistance. The “height” of the structure is used herein to mean the highest point of an inflated portion of the structure. Thus, the additional height of a non-inflatable spire or flagpole projecting above the inflated base would not be included in the height of the structure as that term is employed herein.

Inflatable structure 200 also has netting or other mesh 220 over its entrances (e.g. nylon netting) to prevent children from entering the wind passage 210. A wind passage with netting or some other protecting element should probably have a slightly larger vertical area than those without any protection, because the netting does provide some resistance to the passage of wind.

Another notable difference between the wind passage depicted in FIG. 1 and that depicted in FIG. 2 is that the latter passage is closer to ground level 230. There is a tradeoff here. Placement of the wind passage in the support base higher in the structure is generally better at ameliorating the effects of wind, but can also be problematic in terms of reducing the overall weight bearing capability of the structure. In general, it is contemplated that the wind passage will be at least 0.3 m from ground level.

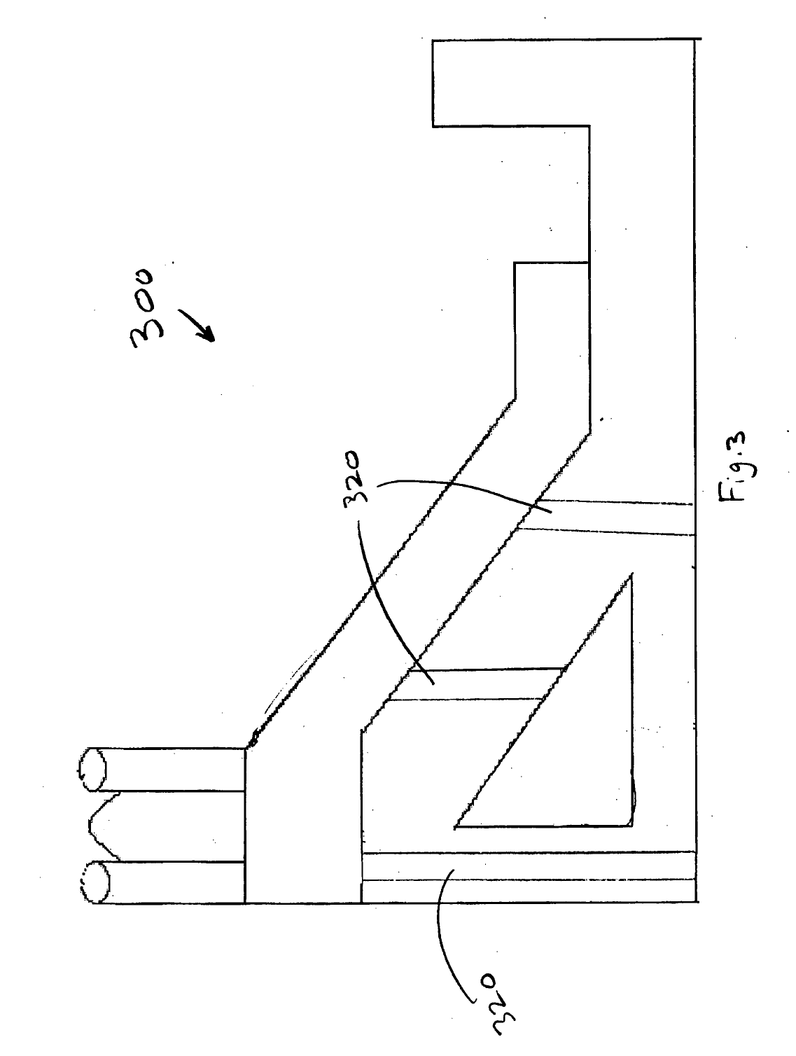

FIG. 3 shows an inflatable play structure 300 that has elongated inflatable tubes 320 positioned to provide support to the slide. In a contemplated class of embodiments, the support tubes 320 are designed to retain air under pressure. This retention of air is accomplished by fitting the tubes with a one way valve for air input, and a manually operated valve for air output. Additionally, such tubes may be interconnected with each other and with other inflatable compartments so that only one source of pressurized air is necessary. A particular embodiment includes horizontally disposed air tubes spaced about 0.7 m apart as well as vertically disposed air tubes.

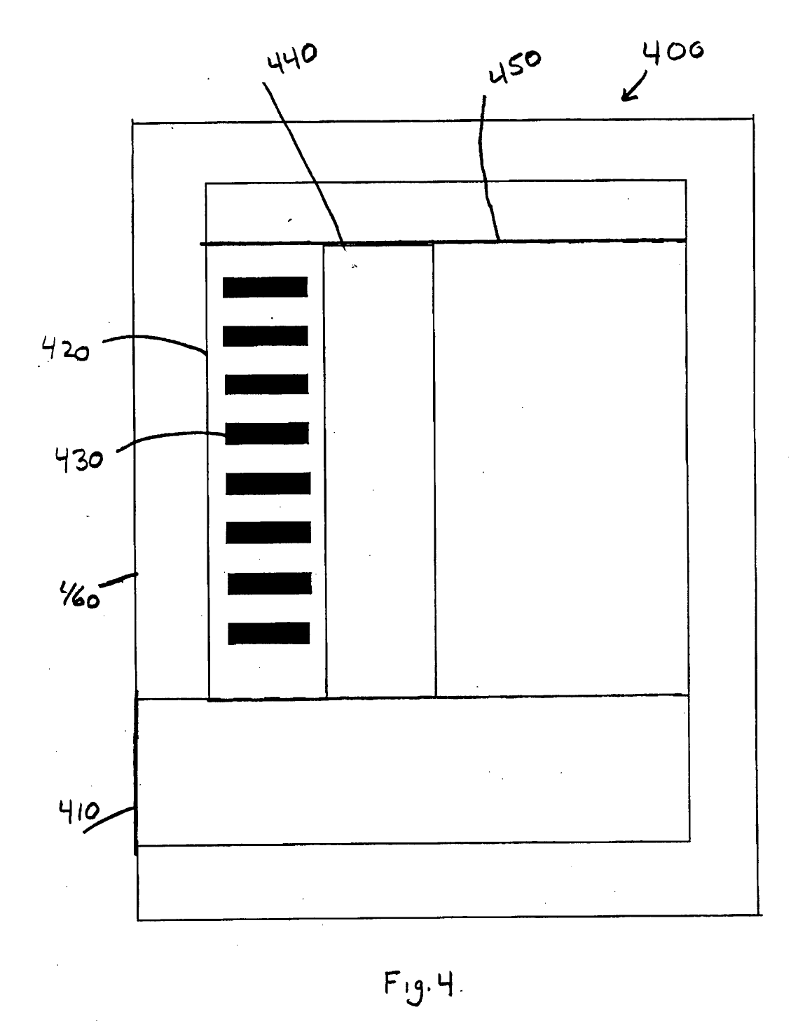

In FIG. 4, an inflatable play structure 400 is displayed in a top down view. In this view, the following structural elements can be seen: an entry 410; a climbing area 420, a rope ladder 430, a railing/side wall 440 and a sliding surface 450.

Entry 410 is formed by a passage though one of the side walls 460 of the structure. The entry 410 functions as an area where a person can enter the play structure and thereafter begin to ascend the rope ladder 430 located in the climbing area 420. The climbing area can be configured to have stairs or some other way of ascending such as by using a securely fastened rope. Having ascended the climbing area, a person may proceed laterally to the sliding surface 450 in order to descend.

Railing/side wall 440 has a dual function: a railing for persons ascending; and a side wall for persons descending. Railing/side wall 440 depends from both sliding surface 450 and climbing area 420. A preferred railing/side wall is inflatable in order to protect people that might contact it while descending on the sliding surface.

Sliding surface 450 has an approximately 30 degree angle of incline, however 30 degrees should not construed as a limitation to the incline of the sliding surface. Sliding surface 450 is preferably constructed of a vinyl or other suitable material that causes sufficiently low friction. Accordingly, the sliding surface can be treated with an additive to control the speed with which a person will descend the slide.

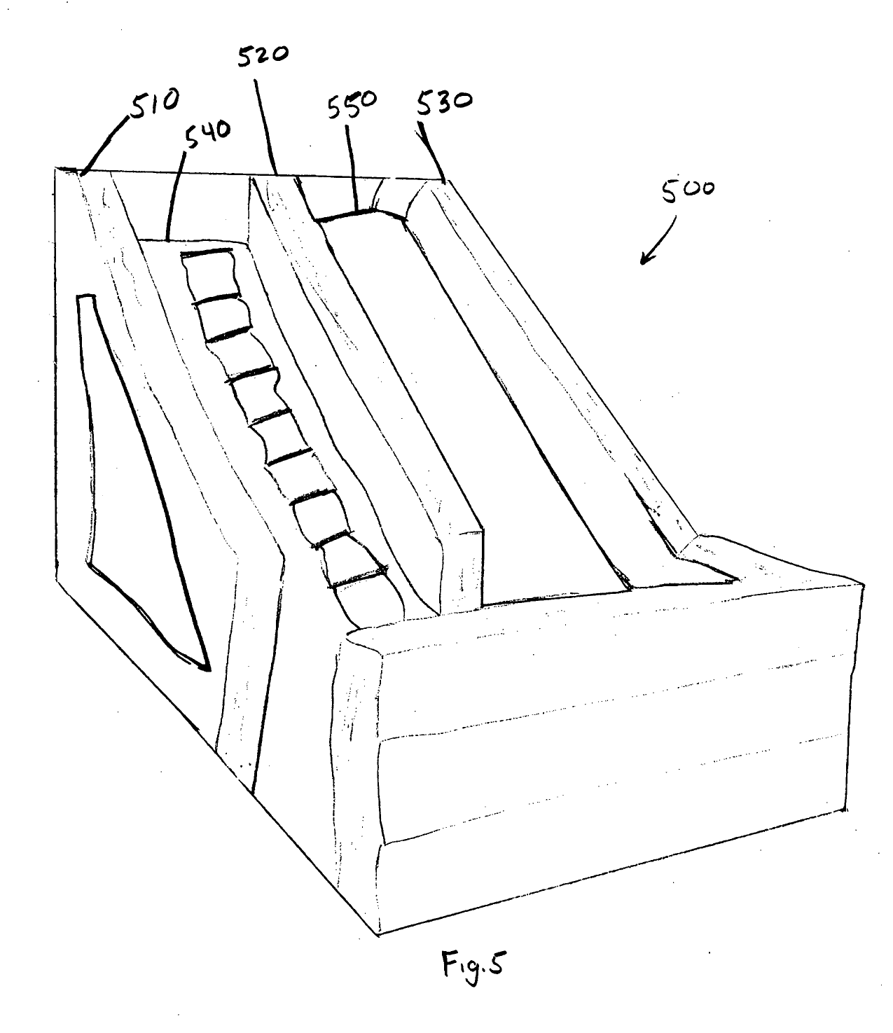

FIG. 5 depicts a play structure 500 with three side walls 510, 520, and 530. Side wall 510 functions as a boundary for the climbing area 540 and side wall 530 functions a boundary to the sliding area 550. Side wall/railing 520 functions as boundaries to both the climbing area 540 and the sliding area 550, and also serves as a railing for people ascending to the top of the slide.

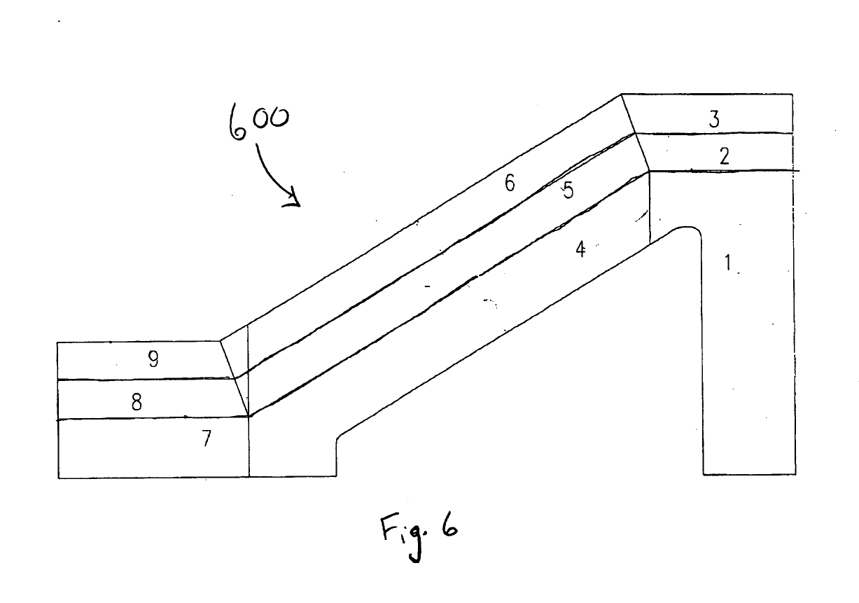

FIG. 6 shows a support structure 600 of a play structure. Each section of the support structure 600 is made up of 9 distinct portions of vinyl denoted by numbers 1-9 in the figure. This 9 portion section is repeated 7 times across the entire face of the play structure. Thus, there are 63 distinct portions of vinyl that provide support to the play structure. Each portion is constructed of 18.5 oz vinyl, however, other suitable materials will suffice.

Thus, specific embodiments and applications of an inflatable slide with a wind passage have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. An improved inflatable play structure with a slide, the structure having a height of at least 4.8 meters, the improvement comprising a wind passage having a vertical cross-section area of at least 0.5 square meters.

2. The structure of claim 1, wherein the vertical cross-section of the wind passage has a substantially triangular shape.

3. The structure of claim 1, wherein the vertical cross-section of the wind passage has a substantially circular cross-section.

4. The structure of claim 1, further comprising an inflatable support base that defines the wind passage.

5. The structure of claim 1, wherein the wind passage is covered with mesh.

6. The structure of claim 1, wherein the slide has a pair of side walls that depend from a sliding surface.

7. The structure of claim 6, wherein one of the side walls is adjacent to a climbing area, and is used as a railing for the climbing area.

8. The structure of claim 1, further comprising an elongated inflatable tube positioned to provide support to the slide.

9. The structure of claim 8, wherein the tube has a manually actuated output valve and a one-way input valve.

10. The structure of claim 1, wherein the vertical cross-section of the wind passage is of at least 0.1 square meters for each meter of height of the structure.

11. The structure of claim 1, wherein the vertical cross-section of the wind passage is of at least 0.2 square meters for each meter of height of the structure.

12. The structure of claim 1, wherein the slide has a height of at least 4.25 meters.
